(19) United States
(12) Patent Application Publication
(10) Pub. No.: US 2007/0249446 A1
(43) Pub. Date: Oct. 25, 2007

(54) Tensioner

(76) Inventors: Minchun Hao, Windsor (CA); Michael Petrashko, Farmington Hills, MI (US); Keming Liu, Sterling Height, MI (US); Oliver Stegelmann, Strathroy (CA)

Correspondence Address: Jeffrey Thurnau;The Gates Corporation, MS: IP Law Dept. 10-A3, 1551 Wewatta Street, Denver, CO, 80202, US

(21) Appl. No.: 11/392,419

(22) Filed: Mar. 29, 2006

(51) Int. Cl. F16H 7/12

(52) U.S. Cl. 474/135; 474/133

(57) ABSTRACT

A tensioner comprising a base, a pivot arm pivotally connected to the base, a pulley journalled to the pivot arm, a first biasing member disposed between the base and the pivot arm, the first biasing member imparting a spring force to the pivot arm over a first operating range, a second biasing member disposed between the base and the pivot arm, and the second biasing member imparting a spring force to the pivot arm at a predetermined pivot arm position, the predetermined pivot arm position disposed within the operating range and beyond which predetermined pivot arm position the second biasing member supplements a spring force of the first biasing member.

### FIELD OF THE INVENTION

The invention relates to a tensioner and more particularly, to a tensioner having a first spring and a second spring, the second spring imparting a spring force to the pivot arm at a predetermined pivot arm position to supplement a spring force of the first spring.

### BACKGROUND OF THE INVENTION

Typically, tensioners comprise an energy storing element, such as a spring, which provides the static torque (or force) output of the device and an energy absorbing element which modifies the device's dynamic force response to outside inputs, for example, some type of type of damping mechanism. The energy storing element and energy absorbing element function throughout the entire working range of the arm, they are not selectively applied within the operating range. The force output by the energy storing element varies depending on the loading of the element (usually defined by position of the tensioner arm relative to the tensioner base) and the spring rate of that element.

Tensioners are known that have more than one energy storing element, for example, tensioners comprising dual torsion springs, which springs are arranged with collinear axes. The collinear springs serve two different functions and each is continually engaged operationally to the pivot arm. The first relates to an energy storing function. The second relates to providing a means of loading a damping or frictional element which damps movement of the tensioner arm.

Representative of the art is U.S. Pat. No. 4,826,471 (1989) to Ushio which discloses an automatic power transmission belt tensioner having spring structure for providing a dual biasing of an idler roller against the power transmission belt. The biasing structure provides a dual biasing of the arm carrying the idler roller including a biasing under torsion and a biasing under compression of the spring structure. In one form, a pair of biasing springs is utilized, one for providing the torsion biasing and one for providing the compressional biasing. In another form, a single spring affects both of the dual biasing actions. The compressional biasing structure includes a pair of cams having cooperating inclined surfaces for effecting compression of the compression spring as a function of the movement of the idler roller arm.

What is needed is a tensioner having a first spring and a second spring, the second spring imparting a spring force to the pivot arm at a predetermined pivot arm position to supplement a spring force of the first spring. The present invention meets this need.

### SUMMARY OF THE INVENTION

The primary aspect of the invention is to provide a tensioner having a first spring and a second spring, the second spring imparting a spring force to the pivot arm at a predetermined pivot arm position to supplement a spring force of the first spring.

Other aspects of the invention will be pointed out or made obvious by the following description of the invention and the accompanying drawings.

The invention comprises a tensioner comprising a base, a pivot arm pivotally connected to the base, a pulley journalled to the pivot arm, a first biasing member disposed between the base and the pivot arm, the first biasing member imparting a spring force to the pivot arm over a first operating range, a second biasing member disposed between the base and the pivot arm, and the second biasing member imparting a spring force to the pivot arm at a predetermined pivot arm position, the predetermined pivot arm position disposed within the operating range and beyond which predetermined pivot arm position the second biasing member supplements a spring force of the first biasing member.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a plan view of the inventive tensioner.

FIG. 2 shows the hubload versus displacement of the tensioner.

FIG. 3 is a plan view schematic of the tensioner showing the available operating ranges of the pivot arm.

FIG. 4 is an exploded view of the tensioner.

FIG. 5 is a side elevation view of the torsion spring.

FIG. 6(a) is a side cross-sectional view of the second spring.

FIG. 6(b) is a top plan view of the second spring.

FIG. 7 is a perspective view of the damping shoe.

FIG. 8 is a cross-sectional view of the damping shoe.

### DETAILED DESCRIPTION OF THE PREFERRED EMBODIMENTS

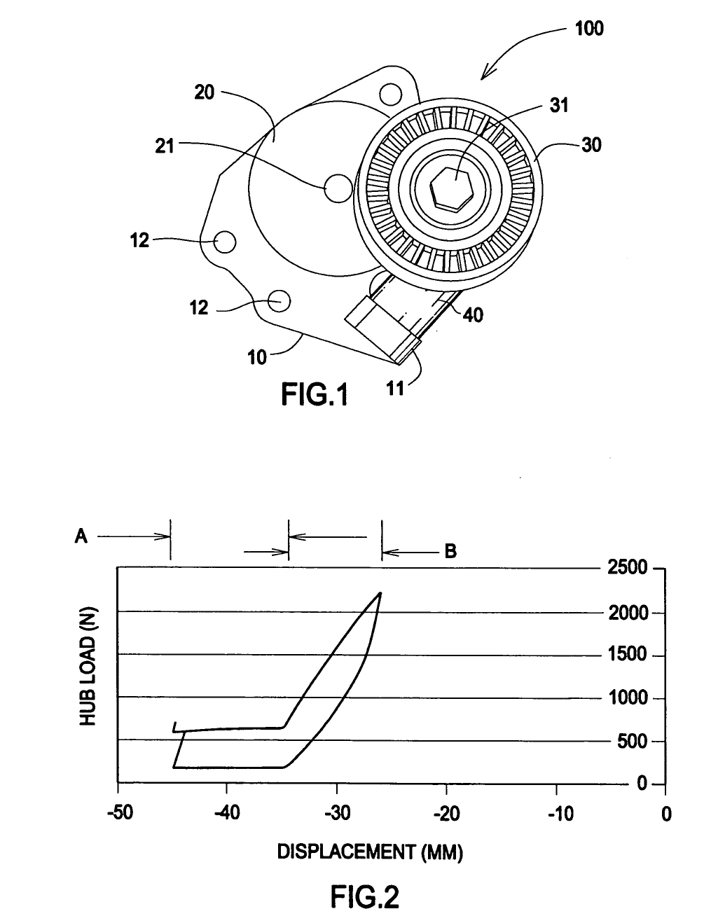

FIG. 1 is a plan view of the inventive tensioner. Tensioner 100 comprises a base 10. Base 10 comprises holes 12 which receive fasteners (not shown) for attaching the tensioner to a mounting surface (not shown), for example an engine. Fasteners may comprise threaded fasteners such as bolts or may also comprise rivets, studs or adhesives.

Pivot arm 20 is pivotally connected to base 10 at pivot 21. Pulley 30 is journalled to pivot arm 20 at axle 31. Axle 31 may comprise any form of bolt or rod known in the art. Pulley 30 engages a power transmission belt, for example, a belt in an accessory drive system.

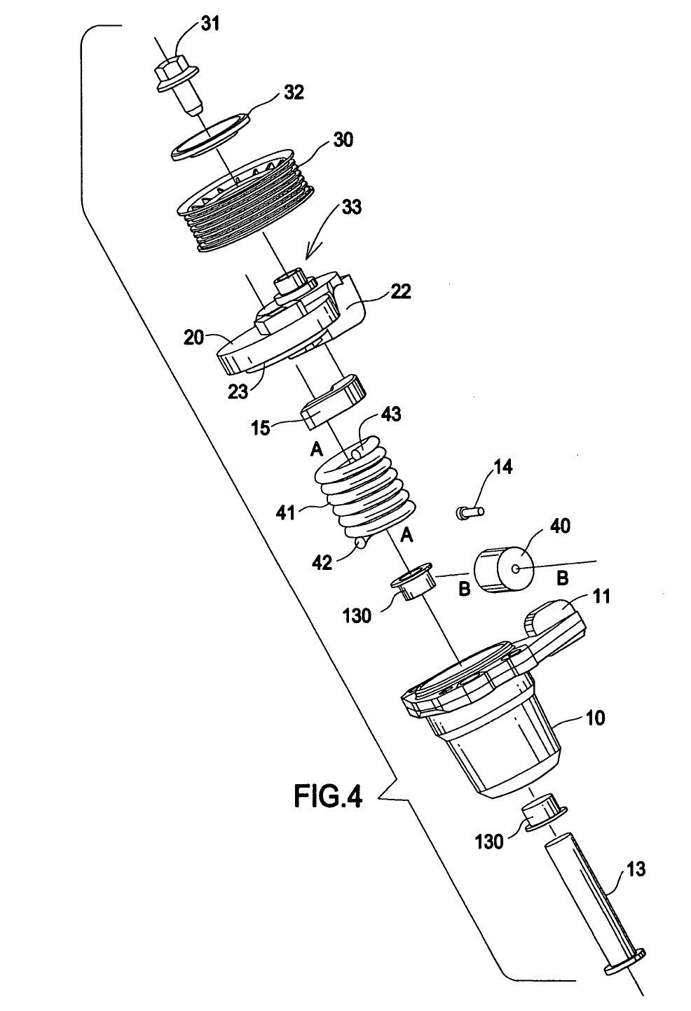

Tensioner 100 comprises a first spring 41 (see FIG. 4) and second spring 40 see FIG. 4. Second spring 40 engages base 10 at engagement 11. The other end of second spring 40 engages pivot arm 20 at engagement 22. The second spring comprises an elastomeric material such as EPDM, HNBR, polyurethane, natural rubbers, synthetic rubbers or a combination of two or more of the foregoing. Spring 40 may also comprise a compressible coil spring or a torsion spring.

FIG. 2 shows the hubload versus displacement of the tensioner. The auxiliary range B is beyond the normal operating range A. Auxiliary range B is characterized by a high spring rate with no preload.

The use of two springs (40, 41) provides a dual tensioner torque output range. The first torque output range is defined by spring 41 and is shown in FIG. 2 as range A. The second torque output range is characterized by the use of the second spring 40 which is intermittently engaged as required and is shown in FIG. 2 as range B. In range B the second torque output range is the sum of the torque of the first spring 41 added to the torque of second spring 40. Spring 40 supplements the spring force of spring 41 upon pivot arm 20 reaching a predetermined angular travel position.

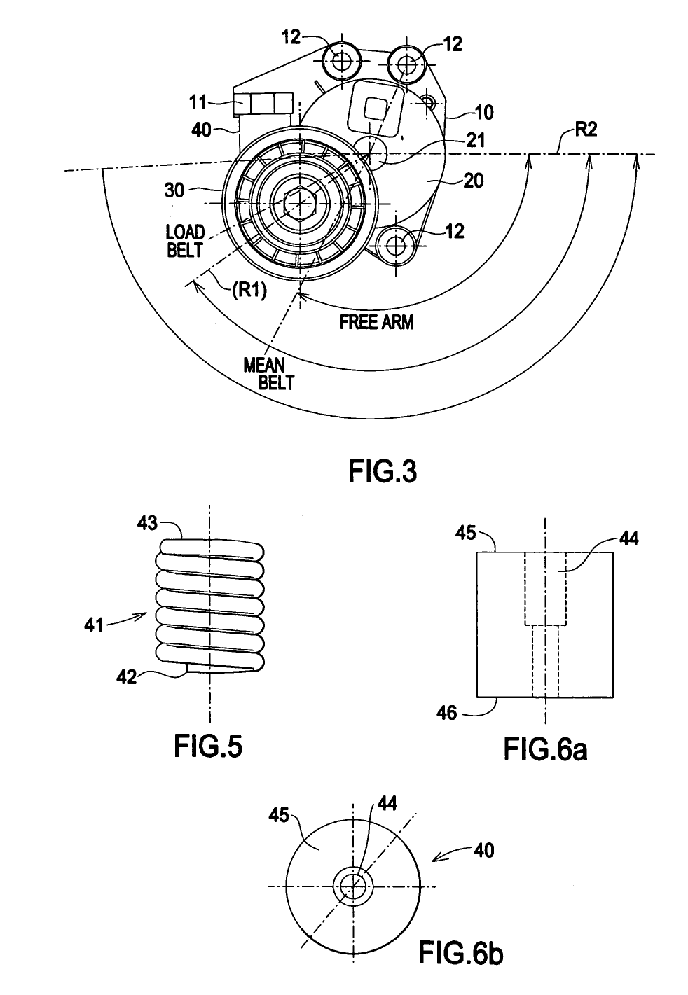

FIG. 3 is a plan view schematic of the tensioner showing the available operating ranges of the pivot arm. With respect to a radial R1, the free arm position is approximately 117°. “Free arm” is the rest position that the spring pushes the pivot arm to when no belt is engaged. The mean belt position is approximately 177° and the load belt position is approximately 143°. These values are only offered by way of example and are not intended to limit the scope of the invention.

The “mean belt position” is the normal operating position of the pivot arm. Spring 40 engages pivot arm 20 at a position equal to or angularly displaced between the “mean belt” position and the “load belt” position.

The “load belt” position is the position to which the pivot arm is moved in order to install a belt on the tensioner pulley. Once a belt is installed the pivot arm typically moves from the load belt position to the mean belt position. The load belt position is typically in the range when spring 40 is in a position between partially and fully compressed. The values for the ranges described herein are merely examples and are not intended to limit any of the ranges described.

FIG. 4 is an exploded view of the tensioner. The tensioner comprises spring 41, in this embodiment a torsion spring, which is contained within base 10. A first end 42 of spring 41 is connected to base 10. A second end 43 of spring 41 is engaged with damping shoe 15. Damping shoe 15 frictionally engages an inner surface 23 of pivot arm 20. Damping shoe 15 damps oscillatory movements of pivot arm 20. Damping shoe 15 is held in position by pressure from spring 41.

Second spring 40 engages mount 11 on base 10. Pin 14 attaches spring 40 to mount 11. Engagement 22 contacts the other end of spring 40. During operation spring 40 is retained between engagement 22 and mount 11. The axis of spring 40 (B-B) is disposed substantially normal to the first spring 41 axis (A-A). It may also be characterized that axis (B-B) is disposed in a plane to which axis (A-A) is normally oriented.

During operation torsion spring 41 is torsionally compressed as pivot arm 20 pivots, thereby imparting a spring force to a belt engaged with pulley 30. Dust guard 31 is used to prevent debris from entering the journal area 33 of pulley 30.

Spring 40 introduces a second resilient spring element whose effect on operation is realized within the normal operating range of the tensioner. Upon reaching a predetermined pivot arm position, spring 40 provides a second spring force to augment the spring force of torsion spring 41. Namely, second spring 40 or biasing member, imparting a spring force to the pivot arm at a predetermined pivot arm position, the predetermined pivot arm position disposed within the operating range and beyond which the second spring 40 supplements a spring force of the first spring 41. Spring 40 may also provide damping for pivot arm movement while it is engaged with the pivot arm.

A lower torque output using a single spring 41 accommodates pivot arm responses to normal belt inputs (with ensuing lower bearing and hub fatigue loads), whereas extreme belt load inputs (and therefore extreme pivot arm movement) are accommodated by both springs, the second spring 40 operating within the auxiliary operating range.

The force of spring 40 can be applied to the pivot arm anywhere in the travel range of the pivot arm, meaning, spring 40 may contact engagement 22 at any place in the range of movement of the pivot arm 20 as required by the desired application.

The spring rate of spring 40 may be constant or graduated, meaning the spring rate is variable as a function of axial compression displacement. Pivot arm forces (and hence belt forces) may be adjusted by using different springs having different spring rates. Spring 40 can comprise conventional springs for example, spiral wound spring for use in a torsional or compressive application, or other resilient materials including plastics, natural and synthetic rubbers, for example polyurethane. In the case of rubber or polymer, spring 40 can be radially supported or unsupported, meaning the spring is supported to prevent undue lateral movement.

Spring 40 also provides a “soft stop” at the end of the pivot arm travel range. Once pivot arm 20 has neared the end of its intended travel, instead of hitting a hard stop, which can result in noise and mechanical damage if the impact with mount 11 is severe enough, pivot arm 20 instead impacts “soft” spring 40.

Pivot 21 comprises shaft 13 and bushes 130. Pivot arm 20 is connected to shaft 13. Bushes 130 are low friction bearings to facilitate pivotal movement of pivot arm 20.

An example of an application for this tensioner includes a belt driven starter generator system, where start mode is much more severe (for example with the tensioner on the belt tight side of the starter generator when it is used as an alternator) than normal operating mode.

Due to the high belt tension required during generator starter start-up or during boosting, a conventional tensioner would need to have an excessively high torque output, which would result in an unacceptably high belt tension during normal engine running mode), or near zero degrees hubload-to-arm angle or near zero degrees wrap angle resulting in reduced tension control/belt take-up during normal engine running mode, also leading to higher arm motion and reduced durability.

The inventive tensioner provides supplemental torque output through operation of the second spring only when the belt load increases to a predetermined level causing pivot arm 20 to engage second spring 40. Otherwise, the torque is developed solely by the first spring 41. Namely, during normal operation and in the normal operating range, the tensioner functions based upon the characteristics of the torsional spring 41. In the normal operating range spring 40 is not under compression between the pivot arm 20 and the base 10. However, during excess belt loading and therefore arm travel beyond the normal operating range, engagement 22 will make contact with spring 40 and thereby with mount 11, thereby compressing spring 40 between pivot arm 20 and base 10. In this configuration the spring force of spring 40 is added to the spring force of torsion spring 41. Spring 40 provides an additional spring force and damping to resist the excess loading event. The location of face 45 of spring 40 in the uncompressed state, see FIG. 6(a), defines an upper pivot arm movement limit for the normal operating range.

Each of the springs 40, 41 provide a spring force and spring rate, which influence tensioner hubload. Even though spring 41 directly influences damping because it provides a force to the damping shoe 15, it also provides a minimal damping force as well caused by torsional winding and unwinding of the spring.

Example spring rates are shown in Table 1. Hubload rate and damping for another example application are shown in Table 2. Table 2 is based on information shown in FIG. 2.

TABLE 1
Spring Rates

| Spring | Spring Rate |
|---|---|
| Spring 41 | 0.2 Nm/deg |
| Spring 40 | 823 N/mm |

TABLE 2
Hubload Rates and Damping Factors

| | | Tensioner |
|---|---|---|
| | Rate | Damping |
| Range | [N/mm] | [%] |
| Normal Operating | 2 | 56 |
| Range (Spring | | |
| 41 Only) | | |
| Extended Range | 185 | 28 |
| (Spring 40 and | | |
| spring 41) | | |

FIG. 5 is a side elevation view of the torsion spring. End 42 is connected to base 10. End 43 is engaged with damping shoe 15.

FIG. 6(a) is a side cross-sectional view of the second spring. Recess 44 receives pin 14. Pin 14 retains spring 40 on base 10, see FIG. 4. Face 45 and face 46 are on opposing ends of spring 40. Faces 45, 46 are typically flat, but may comprise any shape as may be required to engage engagement 22 and mount 11.

FIG. 6(b) is a top plan view of the second spring. Recess 44 is shown to have a graduated form, namely, a first and second diameter for positively engaging pin 14 and not have that engagement interfere with spring output. This prevents spring 40 from disengaging from base 10 when pivot arm 20 is withdrawn from base 10.

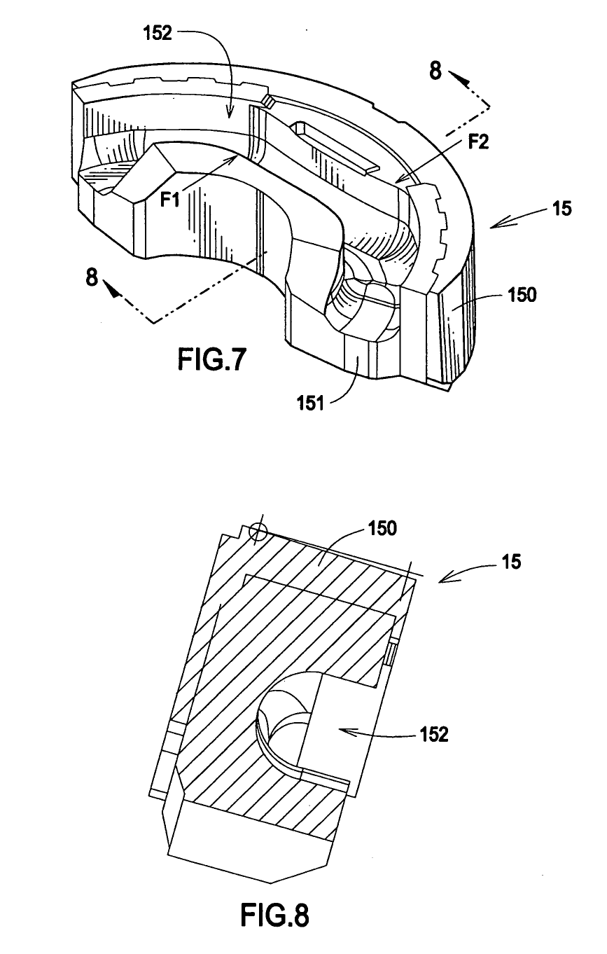

FIG. 7 is a perspective view of the damping shoe. Damping shoe 15 comprises frictional material 150 which has a predetermined coefficient of friction. Frictional material 150 engages surface 23, see FIG. 4. Frictional material 150 is connected to body 151.

Receiving portion 152 engages end 43 of spring 41. End 43 of spring 41 engages receiving portion 152 at two points, namely, F1 and F2. By bearing upon damping shoe at F1 and F2 spring 41 causes damping shoe surface 150 to impart a substantially normal force on surface 23. Spring 41 presses damping shoe 15 normally into surface 23 during torsional loading of spring 41. This typically occurs during pivotal movement of pivot arm 20. The frictional force developed between surface 23 and surface 150 during spring 41 torsional loading is in the range of approximately 1 time to approximately 5 times greater then the frictional force developed by the surfaces 23 and 150 during unloading of torsional spring 41. Hence this comprises an asymmetric damping characteristic.

FIG. 8 is a cross-sectional view of the damping shoe. Receiving portion 152 has a typically “U” shape for engaging spring end 43. The damping shoe comprises an asymmetric damping characteristic to tensioner operation. This means that as the pivot arm moves in response to a belt loading situation the damping force applied to the pivot arm is greater than a damping force applied to the pivot arm when the pivot arm is moving in response to a belt unloading situation. This means that the pivot arm will resist movement caused by belt load increases while allowing less restricted movement of the pivot arm in order to maintain load on the belt during belt load reversals, for example when the belt is slack.

The difference between the damping characteristic for movement of the tensioner arm in a belt loading direction as compared to a belt unloading direction is in the range of approximately 1:1 up to approximately 5:1. In the case where the damping characteristic is greater than 1:1, this is the asymmetric damping characteristic. As noted above, an asymmetric damping characteristic is application in drive systems where the load reversals on the belt cause temporary slack situations to occur in the otherwise non-slack portion of the belt. The damping asymmetry is a feature of the damping mechanism, namely, damping shoe 15, surface 23 and torsion spring 41.

Although forms of the invention have been described herein, it will be obvious to those skilled in the art that variations may be made in the construction and relation of parts without departing from the spirit and scope of the inventions described herein.

We claim:

1. A tensioner comprising:
a base (10);
a pivot arm (20) pivotally connected to the base;
a pulley (30) journalled to the pivot arm;
a first biasing member (41) disposed between the base and the pivot arm, the first biasing member comprising a torsion spring having a first biasing member axis;
a second biasing member (40) disposed between the base and the pivot arm and having a second biasing member axis that is substantially normal to the first biasing member axis; and
the second biasing member imparting a spring force to the pivot arm at a predetermined pivot arm position to supplement a spring force of the first biasing member.

2. The tensioner as in claim 1, wherein the second biasing member comprises a compressible elastomeric material.

3. The tensioner as in claim 1 further comprising:
a damping member engaged between the first biasing member and the pivot arm; and
the damping member imparting an asymmetric damping characteristic.

4. The tensioner as in claim 3 further comprising the damping member frictionally engaged with the pivot arm.

5. A tensioner comprising:
a base (10);
a pivot arm (20) pivotally connected to the base;
a pulley (30) journalled to the pivot arm;
a first biasing member (41) disposed between the base and the pivot arm;
a damping member (15) engaged between the first biasing member and the pivot arm;
the damping member imparting an asymmetric damping characteristic to the tensioner;
a second biasing member (40) disposed between the base and the pivot arm; and
the second biasing member imparting a spring force to the pivot arm at a predetermined pivot arm position to supplement a spring force of the first biasing member.

6. The tensioner as in claim 5, wherein the second biasing member comprises a compressible elastomeric material.

7. The tensioner as in claim 5, wherein the asymmetric damping characteristic is in the range of approximately 1:1 to approximately 5:1.

8. The tensioner as in claim 5, wherein the second biasing member comprises an axis disposed substantially normal to a first biasing member axis.

9. A tensioner comprising:
a base (10);
a pivot arm (20) pivotally connected to the base;
a pulley (30) journalled to the pivot arm;
a first biasing member (41) disposed between the base and the pivot arm, the first biasing member imparting a spring force to the pivot arm over a first operating range;
a second biasing member (40) disposed between the base and the pivot arm; and
the second biasing member imparting a spring force to the pivot arm at a predetermined pivot arm position, the predetermined pivot arm position disposed within the operating range and beyond which predetermined pivot arm position the second biasing member supplements a spring force of the first biasing member.

10. The tensioner as in claim 9 further comprising:
a damping member engaged between the first biasing member and the pivot arm; and
the damping member imparting an asymmetric damping characteristic.

11. The tensioner as in claim 10 further comprising the damping member frictionally engaged with the pivot arm.

12. The tensioner as in claim 10, wherein the asymmetric damping characteristic is in the range of approximately 1:1 to approximately 5:1.

13. The tensioner as in claim 9, wherein the second biasing member comprises an axis disposed substantially normal to a first biasing member axis.

14. The tensioner as in claim 13, wherein the second biasing member comprises a coil spring.

15. The tensioner as in claim 14, wherein the first biasing member comprises a torsion spring.
